(19) United States
(12) Patent Application Publication
(10) Pub. No.: US 2006/0036397 A1
(43) Pub. Date: Feb. 16, 2006

(54) Method and device for ascertaining a position of a characteristic point

(76) Inventor: Robert Dick, Munich (DE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/089,546

(22) Filed: Mar. 24, 2005

Related U.S. Application Data
(60) Provisional application No. 60/579,387, filed on Jun. 14, 2004.

(30) Foreign Application Priority Data
Mar. 24, 2004 (EP) 04 007 094.8

(51) Int. Cl. G06F 15/00

(52) U.S. Cl. 702/150

(57) ABSTRACT

A method and apparatus for identifying the location of at least one characteristic point of a body structure is disclosed. The method includes identifying the location of a plurality of points in an area of the at least one characteristic point, and ascertaining the location of the at least one characteristic point from the location of the plurality of points. The apparatus includes a computational unit for carrying out the method of the invention.

### RELATED APPLICATION DATA

This application claims priority of U.S. Provisional Application No. 60/579,387 filed on Jun. 14, 2004, which is incorporated herein by reference in its entirety.

### FIELD OF THE INVENTION

The invention relates to a method and apparatus for ascertaining a position of one or more characteristic points of a body structure, wherein such characteristic points are referred to as anatomical landmarks and are used to register the body structure to a previously recorded image of the body structure.

### BACKGROUND OF THE INVENTION

Medical navigation systems, such as image-guided surgery systems, provide navigational information to a surgeon via a display, for example. The navigational information can be in the form of images and/or text, and can be used by the surgeon to determine the relative location of a particular bone, joint, tumor, etc. of a patient with respect to one or more pre-operative images of the patient.

Navigation systems use a computer connected to one or more tracking sensors or cameras, such that the position of markers fixed to the patient and/or to instruments can be ascertained, from which the position of the patient and/or instruments can be determined. Such markers, which can include both active emitters and passive reflective markers, can be attached via adapters to a patient and/or to surgical instruments (e.g., a scalpel, forceps, a microscope, a pointer, etc.).

Prior to providing the navigational information, the patient and, more particularly, the area of interest of the patient, is registered. Registration is the process of instructing or teaching the medical navigation system the position of the area of interest in three dimensional space. Once registered, the navigation system correlates the area of interest with the pre-operative images of the patient. Moreover, the navigation system tracks the area of interest and provides visual, numerical and/or textual information with respect to the pre-operative images on the display. Additionally, the navigation system can display the position of surgical instruments utilized on the patient with respect to the pre-operative images in real time.

According to a conventional technique for registering an area of interest, one or more characteristic points or landmarks of a body structure are identified to the navigation system. More particularly, a tip of a pointer, which includes markers for detecting the position of the pointer, is placed on a location that has been previously ascertained by the surgeon by manually touching or probing the location. As the tip of the pointer is lying on or otherwise touching the ascertained location, the pointer is pivoted so as to indicate to the medical navigation system that the present location of the pointer is a characteristic point and should be recorded.

Unfortunately, accurately finding and identifying characteristic points to the medical navigation system can be highly dependent on the skill of the surgeon. Moreover, the repeatability of such conventional techniques can vary widely, even when performed by highly skilled surgeons. As a result, the location of the characteristic points can be imprecise.

### SUMMARY OF THE INVENTION

The present invention provides a method and apparatus that can accurately identify a characteristic point or points to a medical navigation system. Additionally, it would be advantageous for the identification of the characteristic points to have a high degree of repeatability, such that each time the method is executed, substantially the same characteristic point or points are identified.

According to one aspect of the invention, a method for identifying the location of at least one characteristic point of a body structure comprises the steps of identifying the location of a plurality of points in an area of the at least one characteristic point, and ascertaining the location of the at least one characteristic point from the location of the plurality of points.

According to another aspect of the invention, a program for identifying the location of at least one characteristic point of a body structure is embodied in a computer readable medium, and comprises code that identifies the location of a plurality of points in an area of the at least one characteristic point, and code that ascertains the location of the at least one characteristic point from the location of the plurality of points.

According to yet another aspect of the invention, a system for identifying the location of at least one characteristic point of a body structure comprises a processor circuit having a processor and a memory; characteristic point determining code stored in the memory and executable by the processor, the characteristic point determining code including logic that identifies the location of a plurality of points in an area of the at least one characteristic point, and logic that ascertains the location of the at least one characteristic point from the location of the plurality of points.

The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The foregoing and further features of the present invention will be apparent with reference to the following description and drawings, wherein:

FIG. 1 is a schematic diagram of a system that can be used to implement the method of the present invention;

FIG. 2 is an isometric view of a hip, wherein a probe is used to identify a point in the general location of a characteristic point in accordance with an embodiment of the invention;

FIG. 3A is a side view of a body structure wherein points are collected along the surface of the body structure in accordance with an embodiment of the invention;

FIG. 3B illustrates the reconstruction of a body structure contour in accordance with an embodiment of the invention;

FIG. 4 is a flow diagram for identifying a characteristic point on a body structure in accordance with an embodiment of the invention; and

FIG. 5 is a block diagram of a computer system that can be used to implement the method of the invention.

### DETAILED DESCRIPTION

The present invention relates to a method and apparatus for accurately ascertaining a location of one or more characteristic points or landmarks of a body structure. As used herein, a characteristic point or landmark of a body structure refers to a prominent or pronounced feature of a body structure. For example, a characteristic point can be a point that protrudes further out of a body structure than other points on the body structure, a crest or depression in the body structure, an edge of the body structure, etc. In accordance with the present invention, a plurality of points are identified in the vicinity of the characteristic point, e.g., around, near or even on the characteristic point, and from the plurality of points, the characteristic point is ascertained.

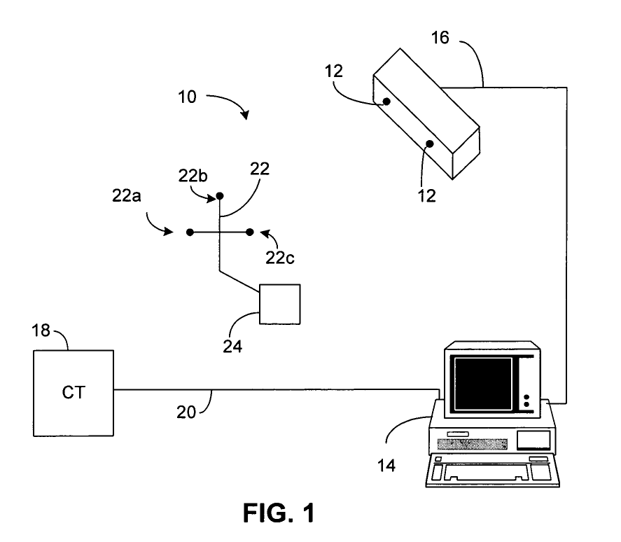

FIG. 1 schematically shows a medical navigation system 10 for implementing the method in accordance with the invention. The system 10 includes infrared cameras 12 and a computer controller 14, wherein the infrared cameras 12 are operatively coupled to the computer controller 14 via a first communications link 16, such as a wired (e.g., ethernet) or wireless (e.g., Bluetooth) communications link. Pre-operative and operative data 18, e.g., a computer tomograph, that originated from an external source can be entered and/or loaded into the computer controller 14 via a second communications link 20 and/or through removable media, e.g., CD-ROM, DVD, memory sticks, etc., (not shown).

The system 10 can ascertain and track the spatial position of an object that includes markers using conventional techniques. For example, a reference star 22 can be coupled to a body structure 24, wherein the reference star 22 includes reflective markers 22a, 22b, 22c that are detectable by the infrared cameras 12. The infrared cameras 12 provide data to the computer controller 14 relating to the spatial position of the markers 22a, 22b, 22c, and the computer controller 14 determines the three-dimensional position of the markers. Alternatively, the cameras 12 can determine the three dimensional position of the markers and provide the information to the computer controller 14.

Since the markers are coupled to the reference star 22, and the reference star is coupled to the body structure 24, the system can determine the three-dimensional position of the body structure 24, provided the geometry of the reference star is known by the system 10. In a similar manner, the system 10 can ascertain the three-dimensional position of an instrument.

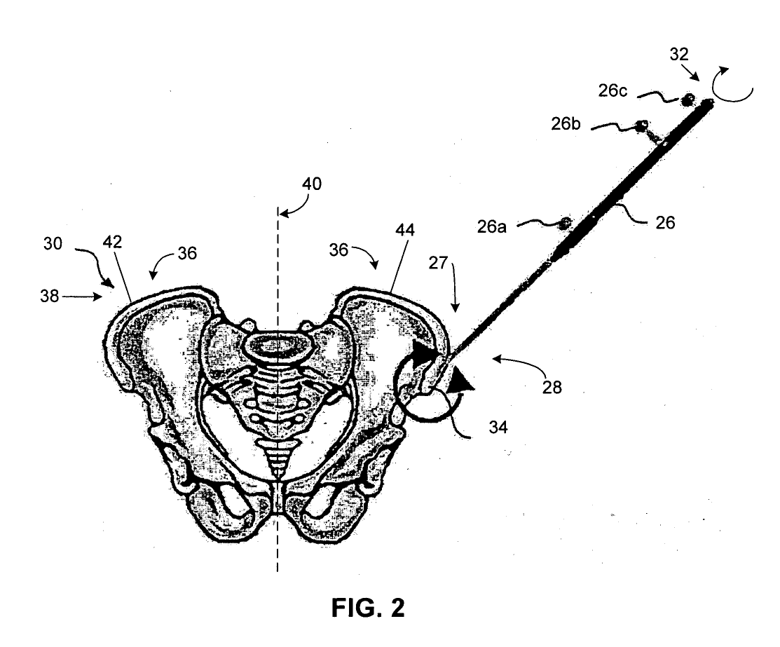

For example, and with further reference to FIG. 2, an instrument 26, such as a probe, includes reflective markers 26a, 26b, 26c that are detectable by the infrared cameras 12 of the system 10. The system 10 can ascertain the three-dimensional position of the markers and, since the markers 26a, 26b, 26c are attached to the instrument 26, the system 10 also can determine the three-dimensional position of the instrument 26. Additionally, the location of a tip 27 of the instrument 26 also can be ascertained, provided the geometry of the instrument 26 is known by the system 10.

The geometry of the instrument 26 can be manually entered into the system 10, e.g., via keyboard entry, or previously stored in the system 10, e.g., in a database, such that the instrument 26 is pre-calibrated and the location of the tip 27 of the instrument 26 can be determined. The computer controller 14 of the system 10 can ascertain the location of a characteristic point 28 from the location of the individual points detected in the area of the characteristic point. The location of the plurality of points can be stored in the system 10 and later used in a subsequent registering method.

In performing the method in accordance with the invention, the general location of the characteristic point 28 can be ascertained, for example, by manually touching or feeling the surface of the body or the skin in an area where the characteristic point 28 is known to be situated. Once the general location surrounding the characteristic point 28 has been ascertained, the instrument 26, such as the tip 27 of a calibrated pointer or probe, is moved or otherwise positioned on a plurality of locations surrounding or on the characteristic point 28. The plurality of locations, for example, form a cloud of points in the form of a spherical surface around the characteristic point. The plurality of points are recorded by the system 10 and, in accordance with the present invention, the characteristic point 28 is ascertained from the position of the plurality of recorded points.

For example, the computer controller 14, using the location of the points in the general location of the characteristic point 28, develops a shape or contour of the region surrounding the characteristic point 28. From the contour of the general location of the characteristic point, the computer controller 14 identifies one or more points that have special significance with respect to other points , e.g., points that protrude from the body structure more/less than any other point on the body structure within the location of the characteristic point or points that are deeper/shallower than other points on the body structure within the location of the characteristic point. As will be appreciated, the criteria for identifying the characteristic point can vary based on the body structure itself and/or on the region of the body structure, e.g., an edge, a depression, a crest, etc. Such criteria are contemplated to be within the scope of the present invention.

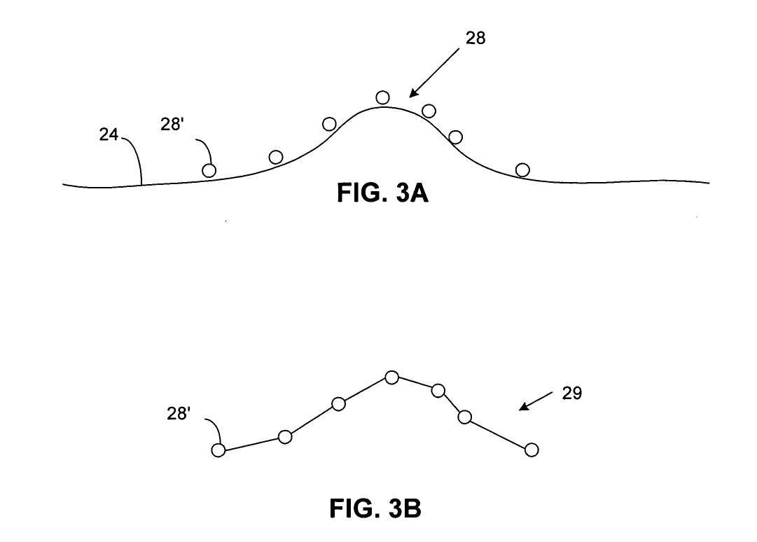

FIG. 3A illustrates an actual body structure 24 and the points 28′ on the body structure 24 that were recorded by the system 10. As can be seen, the points 28′ are in the general location of the characteristic point 28. FIG. 3B illustrates an example of how the computer controller 14 may reconstruct the contour 29 of the body structure 24 using simple linear interpolation. As will be appreciated by those skilled in the art, techniques other than linear interpolation may be employed to estimate the contour of the body surface, and such techniques are contemplated to be within the scope of the present invention.

For example, using the tip 27 of the instrument 26, a plurality of points can be recorded by moving the tip 27 of the instrument 26 to an area of the skin lying over or around a characteristic point 28, e.g., a characteristic point 28 of the hip 30 of FIG. 2. Once the tip 27 is on or near the characteristic point 28, the tip 27 is pressed onto the skin and the instrument 26 is pivoted 32 about the tip 27, thus signifying to the system 10 that the present point should be recorded. Once recorded, the tip 27 is moved to another location about or on the characteristic point and the procedure is repeated until sufficient points have been acquired.

The tip 27, for example, can be placed about the characteristic point 28 in a circular manner 34. In this way, a multitude of points can be recorded by the infrared cameras 12 as a point cloud and stored in the computer controller 14. Using the recorded points, the computer controller 14 can ascertain the position of a characteristic point 28, such as an end position of an edge of the hip 30, for example.

The method in accordance with the invention can be used to ascertain characteristic points in the area of the hip, the spine, the hand, the arm and the legs, e.g., on the knee. In general, however, the method in accordance with the invention can be used to accurately determine characteristic points for any body structure. Moreover, the method in accordance with the invention can be used to determine characteristic points with a high degree of accuracy and repeatability, regardless of the skill of the surgeon.

More particularly, the method in accordance with the invention enables a characteristic point to be ascertained more precisely than conventional techniques of ascertaining the characteristic point. By using a plurality of recorded points to ascertain the characteristic point, any error introduced by a single point is effectively reduced or minimized.

For example, an error introduced using the conventional technique of ascertaining the characteristic point is significant, as only a single point is used to determine the location of the characteristic point. The method in accordance with the invention, on the other hand, preferably uses a plurality of points. An error in any single point of the plurality of points is minimized due to an averaging effect created by determining the characteristic point based on a plurality of points. As a result, a location of a characteristic point that is highly accurate and can be easily reproduced, regardless of the skill of a surgeon.

As was noted previously, the plurality of points can be selected by moving the tip 27 of an instrument 26, such as a blunt pointer or probe, on a plurality of locations surrounding the characteristic point 28 or even on the characteristic point 28. For example, various points on the surface of the body (e.g., on the skin or on a substance lying on the skin, wherein the skin is not injured or pierced) that are in the general area of the characteristic point 28 can be identified by the tip 27 of the instrument 26, and those points can be recorded. However, in principle it is possible for the tip 27 of the instrument 26 to be moved through the skin and directly onto the body structure, such as the hip 30, for example, to record a plurality of points on the body structure itself.

If the recorded points were taken on the surface of the skin, then the thickness of the skin can be taken into account in calculating the position of the characteristic point 28. For example, the characteristic point of the body structure can be calculated as a point which lies below the point ascertained on the surface of the skin by a distance substantially equal to the thickness of the skin. Thus, using known reference models of the body structure, e.g., a typical, generic or standard image of body structure and an estimated or actual measurement of skin thickness (including any fatty tissue below the skin), it is possible to register the body structure without an actual computer tomograph (CT) recording of the body structure.

In a similar manner, by shrinking or otherwise compensating for the thickness of the skin, the position of one or more characteristic points or of one or more point clouds can be used to compare or register a body structure or bone structure. For example, the points or point clouds that describe a surface area or skin area of the body can be shrunk by the thickness of the skin, thereby depicting the surface of the body structure itself.

In one embodiment, a plurality of characteristic points 28 of a body structure are ascertained, wherein the characteristic points 28 are chosen so as to lie on a symmetrical portion 36, a characteristic plane 38, or axis 40 of the body structure 24. For example, two points 42, 44 can be chosen on the hip 30 that lie symmetrically with respect to a plane of symmetry or mid-sagittal plane of the hip. The mid-sagittal plane, which generally is determined during the planning stage of a hip operation, can be calculated from the position of the two ascertained characteristic points as the plane of symmetry with respect to the two characteristic points.

Additionally, the position of one or more points that were ascertained in accordance with the invention can be used in a so-called paired point match. More specifically, a virtual body structure or virtual bone structure that had been obtained using a computer tomography, for example, is compared with the real body structure or real bone structure so as to register the real body/bone structure with the virtual body/bone structure.

For example, a characteristic point from the virtual body structure is assigned to a characteristic point of the real body structure. Since the characteristic point of the real body structure is ascertained in accordance with the method described above, the spatial position of the characteristic point is known. Thus, once one or more characteristic points have been assigned in pairs, the real body structure is registered. Moreover, by attaching a reference star 22 to the body structure 24, the body structure can be tracked so as to maintain registration as the body structure 24 is moved with respect to the cameras 12.

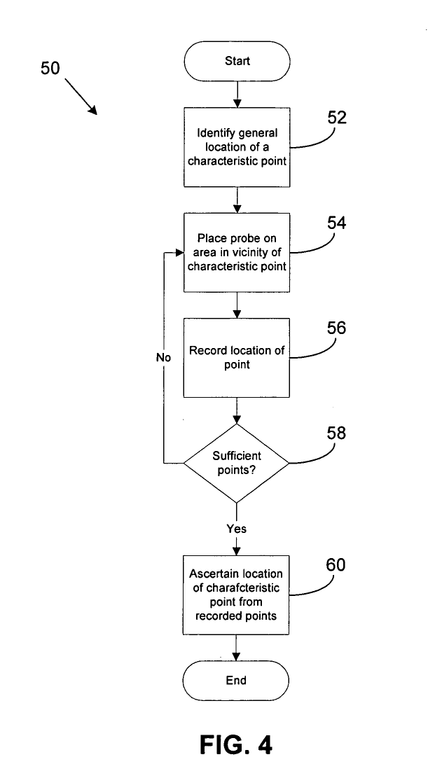

Moving now to FIG. 4, a flow diagram 50 illustrating the method of determining a characteristic point in accordance with an embodiment of the invention is shown. The flow diagram includes a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at step 52, a general area of the body structure 24 is identified where a characteristic point 26 is known to exist. The area can be identified, for example, by palpating an area of the body structure 24 so as to locate a general location of the characteristic point. Once the general location of the characteristic point is located, a tip 27 of an instrument 26, e.g., a probe, is placed on a point within the general location, as indicated at step 54.

As was noted previously, the instrument 26 can be a trackable instrument, wherein a navigation system 10 can ascertain the three-dimensional spatial position of the instrument 26 and record that position. The navigation system can be instructed to record the three-dimensional position of the point by pivoting the instrument about the point, e.g. retaining the tip 27 of the instrument 26 on the point and rotating the instrument about the point. As will be appreciated, however, numerous other techniques can be employed to instruct the navigation system 10 to record the location of the three dimensional position of the point, including, for example, a boolean signal, e.g., a push-button closure, a voice command or holding the instrument substantially steady for a pre-determined time period, e.g., five seconds.

Once the location of the point has been recorded, it is determined whether additional points will be acquired or whether sufficient points have been acquired, as indicated at step 58. Generally speaking, the accuracy of the location of the characteristic point is increased as the number of acquired points is increased. The number of acquired points can be less than five, greater than five and less than ten, greater than ten and less than fifteen, greater than fifteen and less than twenty or greater than twenty, for example.

If additional points are to be acquired, the method moves back to step 54 and the process is repeated. As was noted previously, the tip 27 of the probe 26 can be moved in a circular pattern around the general location of the characteristic point 28. Alternatively, the tip 27 of the probe 26 can be moved in a random pattern around the general location of the characteristic point 28. In yet another variation, points are obtained on each side of the characteristic point, e.g., surrounding the characteristic point on all sides.

If sufficient points have been acquired, then at step 60 the location of the characteristic point in three-dimensional space is ascertained. For example, the points acquired in the general location of the characteristic point 26 can be used to calculate a surface contour of the body structure 24. Based on the calculated surface contour, a point on the surface contour can be identified as a characteristic point, e.g., a point that protrudes out further than other points, a recess or deep portion, etc.

Accordingly, a method for ascertaining the location of a characteristic point has been disclosed. The method provides increased accuracy in the location of the characteristic point with respect to conventional techniques. Moreover, the method yields a high degree of repeatability, such that each time the method is performed the location of the characteristic point is identified to be in substantially the same location.

The above described methodology can be implemented by a computer program which, when it is loaded onto a computer or is running on a computer, performs one or more of the method steps described above. The program can be embodied in a program storage medium.

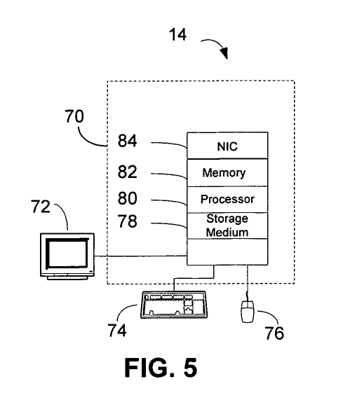

Moving to FIG. 5 computer controller 14 for executing a computer program in accordance with the present invention is illustrated. The computer controller 14 includes a computer 70 for processing data, and a display 72 for viewing system information. The technology used in the display is not critical and may be any type currently available, such as a flat panel liquid crystal display (LCD) or a cathode ray tube (CRT) display, or any display subsequently developed. A keyboard 74 and pointing device 76 may be used for data entry, data display, screen navigation, etc. The keyboard 74 and pointing device 76 may be separate from the computer 70 or they may be integral to it. A computer mouse or other device that points to or otherwise identifies a location, action, etc., e.g., by a point and click method or some other method, are examples of a pointing device. Alternatively, a touch screen (not shown) may be used in place of the keyboard 74 and pointing device 76. A touch screen is well known by those skilled in the art and will not be described in detail herein. Briefly, a touch screen implements a thin transparent membrane over the viewing area of the display 72. Touching the viewing area sends a signal to the computer 70 indicative of the location touched on the screen. The computer 70 may equate the signal in a manner equivalent to a pointing device and act accordingly. For example, an object on the display 72 may be designated in software as having a particular function (e.g., view a different screen). Touching the object may have the same effect as directing the pointing device 76 over the object and selecting the object with the pointing device, e.g., by clicking a mouse. Touch screens may be beneficial when the available space for a keyboard 74 and/or a pointing device 76 is limited.

Included in the computer 72 is a storage medium 78 for storing information, such as application data, screen information, programs, etc. The storage medium 88 may be a hard drive, for example. A processor 80, such as an AMD Athlon® processor or an Intel Pentium IV® processor, combined with a memory 82 and the storage medium 78 execute programs to perform various functions, such as data entry, numerical calculations, screen display, system setup, etc. A network interface card (NIC) 84 allows the computer 70 to communicate with devices external to the computer controller 14. The actual code for performing the functions described herein can be easily programmed by a person having ordinary skill in the art of computer programming in any of a number of conventional programming languages based on the disclosure herein. Consequently, further detail as to the particular code itself has been omitted for sake of brevity.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for identifying the location of at least one characteristic point of a body structure, comprising the steps of:
identifying the location of a plurality of points in an area of the at least one characteristic point; and
ascertaining the location of the at least one characteristic point from the location of the plurality of points.

2. The method of claim 1, wherein the step of ascertaining the location of the t least one characteristic point includes the step of developing a contour of a surface in the area of the at least one characteristic point from the location of the plurality of points.

3. The method of claim 2, wherein the step of developing a contour includes the step of identifying a prominent feature on the contour as the at least one characteristic point.

4. The method of claim 3, wherein the step of identifying a prominent feature on the contour includes at least one of identifying a point on the contour that protrudes out further than other points on the contour and identifying points on the contour that protrude out less than other points on the contour.

5. The method of claim 1, wherein the step of identifying the location of the plurality of points includes the steps of:
tracking a location of a tip of an instrument;
placing the tip of the instrument on one of the plurality of points; and
recording the location of the tip of the instrument.

6. The method of claim 5 wherein the step of recording the location of the tip of the instrument includes initiating the recording process, wherein initiating includes at least one of pivoting the instrument about the one point, using a voice command, providing a boolean command and holding the instrument substantially steady for a predetermined length of time.

7. The method of claim 5, further comprising the step of moving the tip of the instrument to each of the plurality of points in at least one of a pattern surrounding the characteristic point, a circular pattern and a random pattern.

8. The method of claim 1, wherein the step of identifying the location of the plurality of points in an area of the at least one characteristic point includes identifying the at least one characteristic point on at least one of a hip, a hand, an arm, a leg, a knee and a spine.

9. The method of claim 1, wherein the step of identifying the location of the plurality of points in an area of the at least one characteristic point includes the step of identifying the location of the plurality of points on a surface of a skin layer.

10. The method of claim 9, wherein the step of ascertaining the location of the at least one characteristic point from the location of the plurality of points includes the step of ascertaining the at least one characteristic point to be below the skin surface a distance substantially equal to a thickness of the skin layer and any intermediate layers.

11. The method of claim 10, wherein the step of ascertaining the location of the at least one characteristic point from the location of the plurality of points includes the step of shrinking the skin layer so as to depict a surface of the body structure.

12. The method of claim 1, further comprising the step of using the at least one ascertained characteristic point or the plurality of points to register the body structure.

13. The method of claim 12, wherein the step of using the at least one ascertained characteristic point or the plurality of points to register the body structure includes the step of correlating the registered body structure to an actual image of the body structure.

14. The method of claim 12, wherein the step of using the at least one ascertained characteristic point or the plurality of points to register the body structure includes the step of correlating the registered body structure to a generic image of the body structure.

15. The method of claim 1, wherein the step of identifying the location of the plurality of points in an area of the at least one characteristic point includes the step of identifying the location of the plurality of points directly on the body structure.

16. The method of claim 1, further comprising the step of choosing the at least one characteristic point so as to lie on at least one of a symmetrical portion of the body structure, a characteristic plane of the body structure and an axis of the body structure.

17. The method of claim 1, further comprising the step of using the at least one ascertained characteristic point in a paired-point match, wherein at least one characteristic point from a virtual body structure is matched to at least one ascertained characteristic point of the actual body structure.

18. A program embodied in a computer readable medium for identifying the location of at least one characteristic point of a body structure, comprising:
code that identifies the location of a plurality of points in an area of the at least one characteristic point; and
code that ascertains the location of the at least one characteristic point from the location of the plurality of points.

19. A system for identifying the location of at least one characteristic point of a body structure, comprising:
a processor circuit having a processor and a memory;
characteristic point determining code stored in the memory and executable by the processor, the characteristic point determining code comprising:
logic that identifies the location of a plurality of points in an area of the at least one characteristic point; and
logic that ascertains the location of the at least one characteristic point from the location of the plurality of points.
